(19) United States
(12) Patent Application Publication
(10) Pub. No.: US 2011/0114625 A1
(43) Pub. Date: May 19, 2011

(54) FOOD HOLDING CABINET WITH SELF-ALIGNING AND ADDRESSABLE POWER SUPPLIES

(75) Inventors: TERRY TAE-IL CHUNG, BARTLETT, IL (US); MICHAEL VALENTINO, GENEVA, IL (US); JEFF SCHROEDER, LAKE ZURICH, IL (US); MARK KMIECIK, CHICAGO, IL (US); DAVID REID, PALATINE, IL (US); PAUL BERLAND, ELGIN, IL (US); KERRY BERLAND, CHICAGO, IL (US); DOUGLAS REINKING, CHICAGO, IL (US)

(73) Assignee: PRINCE CASTLE, INC, CAROL STREAM, IL (US)

(21) Appl. No.: 12/618,965

(22) Filed: Nov. 16, 2009

(51) Int. Cl. F27D 11/00

(52) U.S. Cl. 219/385

(57) ABSTRACT

A universal food holding cabinet has multiple compartments, the temperatures of which are under software control by microprocessors or microcontrollers located on power supply circuit boards for corresponding compartments. Each compartment can have different temperature control requirements with different requirements being met by a different program in different processors, or different operating parameters for the same program. The cabinet is configured to prevent the power supply boards from being installed incorrectly, to provide an address to a power supply circuit board when it is installed and by which a power supply circuit can be addressed by a master controller.

### BACKGROUND

Many restaurants' success depends on how quickly customers can be served with food items that a customer orders. If the rate at which a restaurant cooks food products equals the rate at which those same food products are being ordered and sold, a fast food restaurant can theoretically have freshly-cooked foods ready to serve for customers as they arrive. Since it is not always possible to match cooked-food production with customer ordering rates, and since fast food restaurant customers expect to receive their ordered food items quickly, many fast food restaurants pre-cook various food items and keep them warm, ready for sale until a customer arrives and purchases a pre-cooked food item.

Pre-cooked food items cannot be stored for prolonged periods and must be kept warm while they are being held. Prolonged heating causes food texture and flavor to deteriorate. The time that a food product can be kept warm yet remain palatable will vary with each type of food product. It is therefore beneficial to have an ability to store different types of foods at different temperatures and keep track of the time that a food has been kept warm.

Food holding cabinets are well known in the prior art. A problem with prior art food holding cabinets, as with most commercial restaurant equipment is that they sometimes fail and require a service technician to repair. In keeping with food service operators' goal of reducing cost, it would be desirable to provide on-site service ability to a food holding cabinet whereby repairs can be effectuated by a restaurant operator, on-site and without having to call a service technician.

### BRIEF DESCRIPTIONS OF THE DRAWINGS

Preferred embodiments are set forth in the following detailed description and accompanying drawings in which like reference numerals represent like parts.

FIG. 1 is a perspective view of a universal food holding cabinet with snap-in escutcheons;

FIG. 2 is a front view of the oven depicted in FIG. 1, with the top panel removed;

FIG. 3 is a rear view of the oven depicted in FIG. 2;

FIG. 4 is a perspective view of the rear of the oven shown in FIG. 3 with the uppermost escutcheon removed from the rear face of the oven, and showing the oven's right-side panel (when viewed from the front) removed to reveal the right side of the oven chassis and attachment points of the escutcheons;

FIG. 5 is a perspective view of the front of the oven shown in FIG. 3 with the uppermost escutcheon removed from the front face of the oven, and showing the oven's left-side panel removed to reveal the right side of the oven chassis and attachment points of the escutcheons;

FIG. 6 is an isolated, perspective view of a control board that carries electronic devices that control heat transfer elements and which are coupled to user interfaces on the cabinet escutcheons;

FIG. 7 depicts the control board of FIG. 6, partially removed to reveal connectors on the circuit board and connectors on a mother board for the cabinet;

FIG. 8 is a perspective view of the right side of the cabinet as viewed from the rear; and

FIG. 9 is a block diagram of electronics in the cabinet.

### DETAILED DESCRIPTION

The contents of U.S. patent application Ser. No. 12/618,939 entitled, UNIVERSAL FOOD HOLDING CABINET WITH SNAP-IN ESCUTCHEONS, filed on Nov. 16, 2009, which is assigned to the assignee of this application, are incorporated herein by reference.

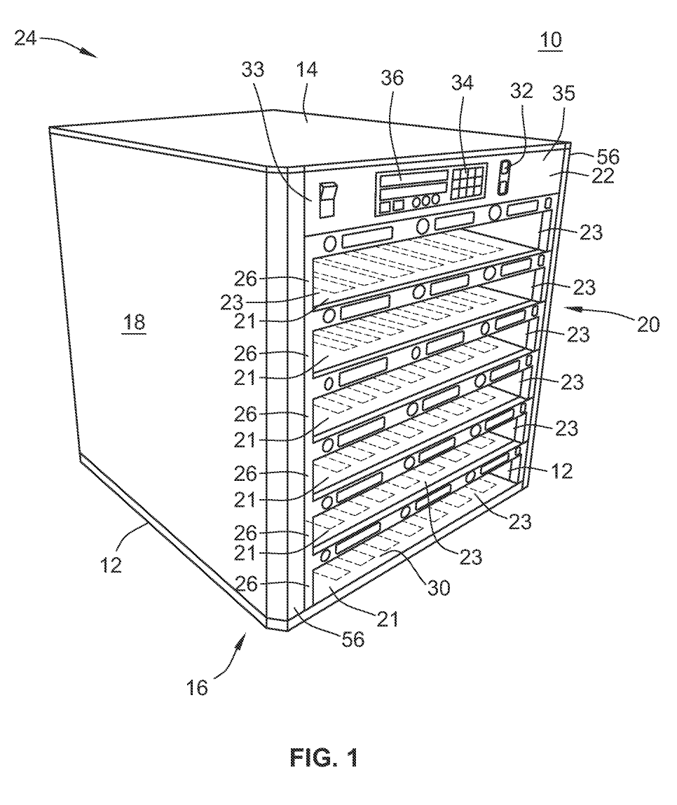

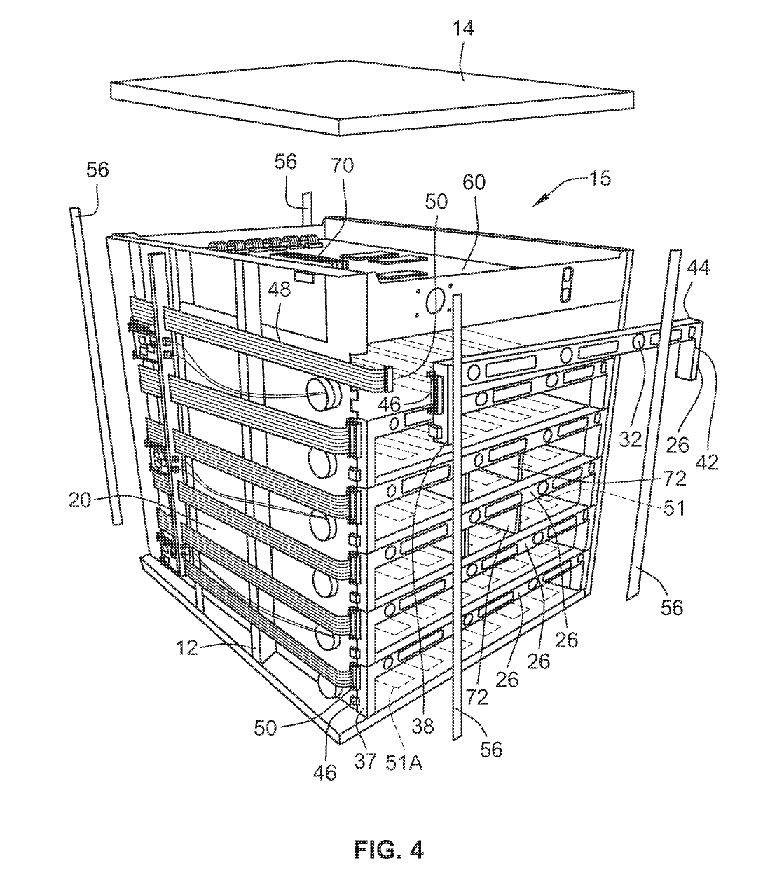

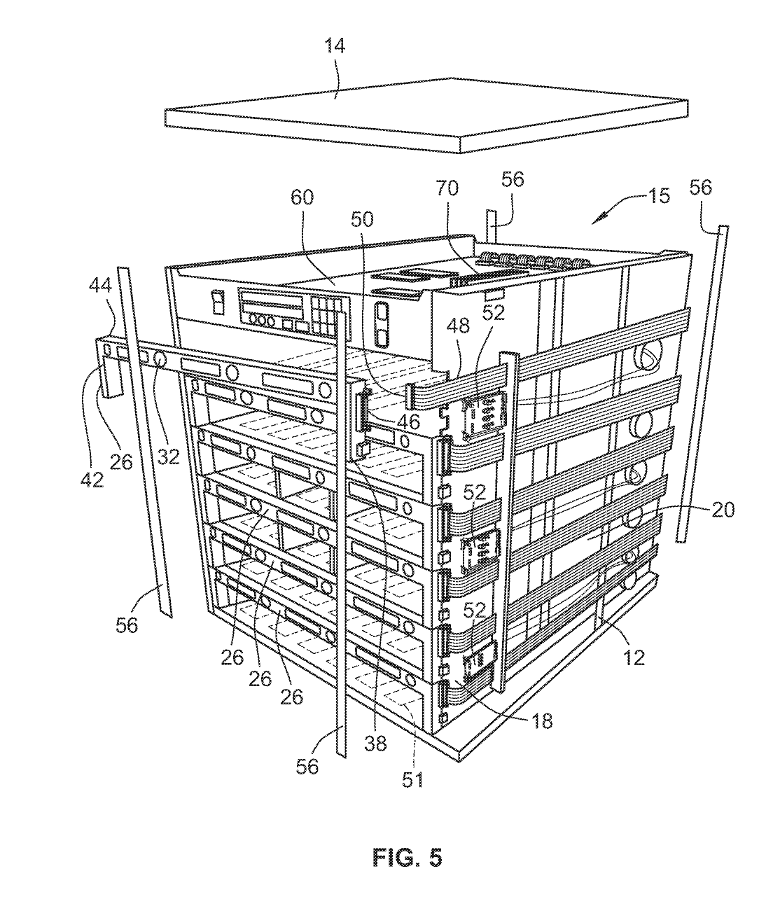

FIG. 1 is a perspective view of a temperature-controlled food holding cabinet 10. The holding cabinet 10 is comprised of a metal frame or chassis 12, best seen in FIG. 4 and FIG. 5. The chassis 12 is comprised of various stamped and/or rolled metal components that form a substantially cube-shaped oven-like cabinet subdivided into several separate, temperature-controlled food-holding compartments 23. Depending on the placement of heating elements as described more fully below, each shelf 21 is capable of maintaining one or more different temperatures for different types of food items.

As can be seen in FIG. 1, the cabinet 10 is comprised of a top panel 14, a bottom panel 16, a left-side panel 18, a right-side panel 20, a front face 22 and a rear face 24 not visible in FIG. 1. The top panel 14 covers electronic components, which include a master controller computer, cables and connectors that provide various connections between a front panel user interface and the master controller. A top panel 35 of the front face 22 provides several user interfaces by which a cabinet operator can configure the cabinet but also quickly determine its status by visually reading corresponding user interfaces. As can be seen in FIGS. 4 and 5, the side panels 18 and 20 also cover various electronic circuits and associated wiring.

The front face 22 and the rear face 24, are provided with snap-into-place bezels, which are also referred to herein as snap-in escutcheons or simply escutcheons, and which are identified in the figures by reference numeral 26. As can be seen in the co-pending application identified above and as described more fully below, the escutcheons 26 cover edges of the shelves 21. They also define openings into food storage compartments 23. And, the escutcheons 26 provide user interface devices, which include display devices and user-actuated control devices, the function and operation of which is described more fully below.

Importantly, the escutcheons 26 are used on both the front and rear faces of the cabinet 10 and are interchangeable. The escutcheons 26 are configured to have electrically parallel electrical connectors 46 at each end of the escutcheon 26, which mate with chassis-located connectors described more fully below but preferably located proximate one side (left or right) of each cabinet face (front or rear).

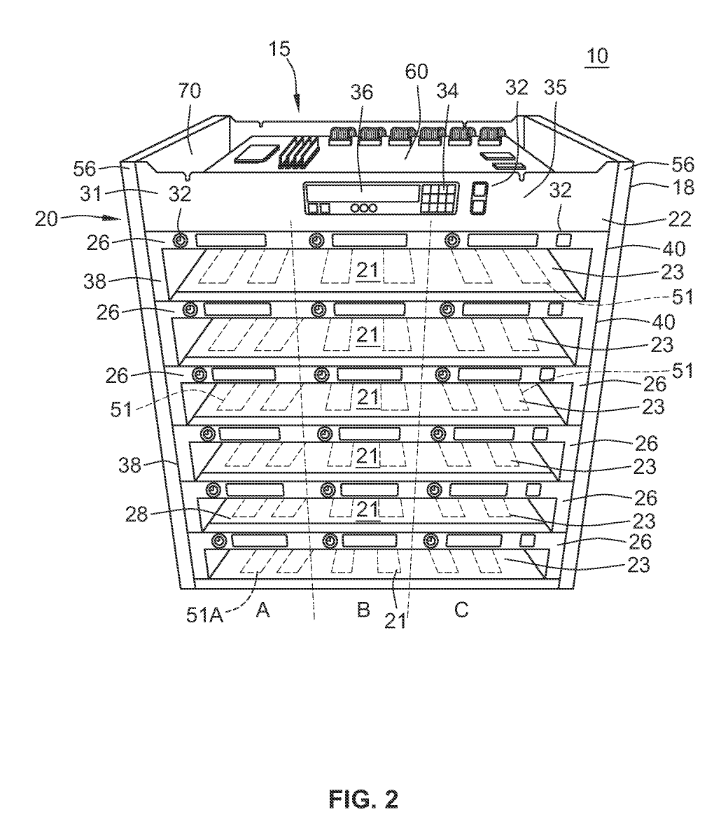

FIG. 2 is a front view of the cabinet 10 with the top panel 14 removed to reveal cabinet electronics equipment in the cabinet's electronics compartment 15, which is covered and protected by the top panel 14. The electronic equipment in the electronics compartment 15 includes at least one “master” computer/controller 70 for other electronics in the cabinet 10.

Below the electronics compartment 15 are several horizontal and substantially planar, thermally-conductive shelves 21. The shelves 21 are vertically separated from each other in the chassis 12 and fixed between the left side panel 18 and right side panel 20 to define food-holding compartments 23. The vertical separation distance between each shelf 21 defines the height of each compartment 23 and thus the maximum height of a food item or the packaging for a food item.

The shelves 21 and the compartments 23 are considered to extend horizontally across most of the width of the cabinet 10. The shelves 21 are preferably made from thermally conductive materials such as aluminum, copper or steel, so that the temperature of the food holding compartments 23 can be maintained by the transfer of heat from the shelf 21 into the compartment 23, or from the compartment 23 into the shelf 21. Different types of temperature control elements 51 are embedded into each shelf or otherwise thermally coupled thereto. Compartment temperature can thus be achieved by controlling the temperature of the temperature control elements 51, which in turn controls the temperature of the thermally conductive shelves 21, which define the compartments 23.

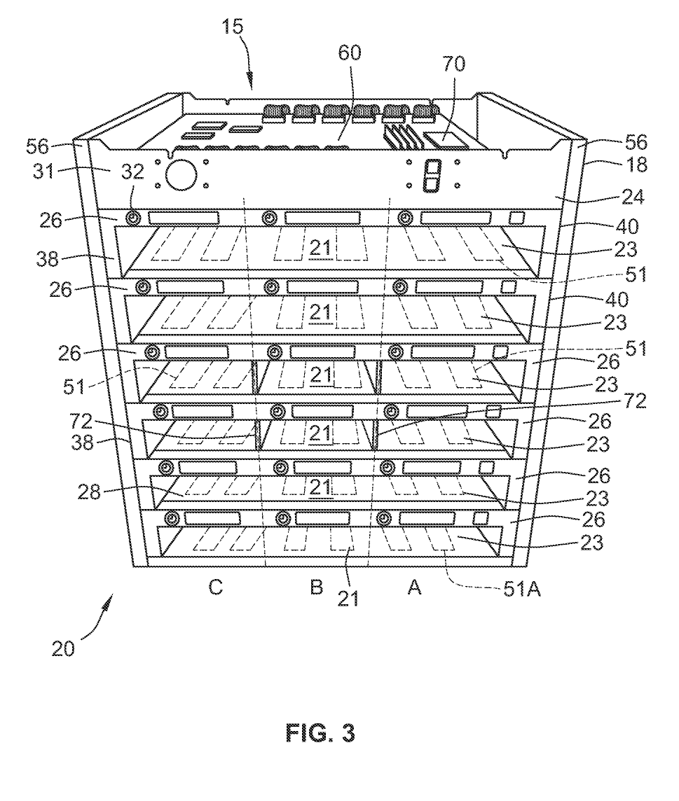

In a preferred embodiment, the shelves 21 of the cabinet 10 are subdivided horizontally into separate, temperature-controlled zones. The different zones for each shelf are identified in FIGS. 2 and 3 by the letters A, B and C. When the cabinet 10 is viewed from the front, as shown in FIG. 2, the “A” zone of each shelf is at the left-hand side of the cabinet 10; the “C” zone is located on the right-hand side of the cabinet 10; the “B” zone is located between the A and C zones. Temperature control of the separate zones A, B and C is accomplished by using separate temperature control elements in each zone, and which are thermally coupled preferentially to one zone over the others. By way of example, zone A in a first shelf has a heater embedded in the shelf and centered in the “A” zone. It therefore provides most of its heat output into the A zone.

A heater 51 embedded in the shelf 21 and centered in the “A” zone is separately controlled from heaters 51 that are embedded in the same shelf 21 and centered in zones B and C and vice versa. In an alternate embodiment, zones A, B and C and corresponding embedded heaters 51 are thermally isolated from each other using a thermal break, such as those disclosed in co-pending application Ser. No. 12/267,449 entitled, BIFURCATED HEATED TOASTER PLATEN, which is assigned to the assignee of this application. The content of the co-pending application Ser. No. 12/267,449 is incorporated herein by reference, at least with regard to heated platens and the thermal breaks disclosed therein. In yet another embodiment, the zones are isolated from each other by walls 72, which extend between the top and bottom of the compartments 23, i.e., vertically-adjacent shelves 21 that define a compartment 23 between them.

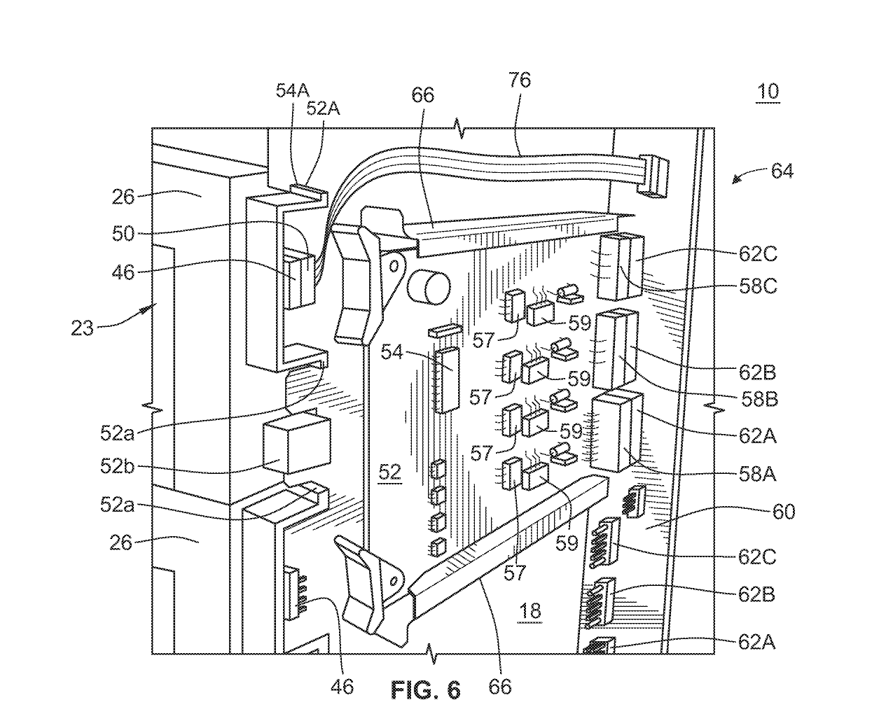

FIG. 6 is an isolated, perspective view of a control board 52 that carries electronic devices that control one or more heat transfer elements in the shelves 21 that define the compartments 23 of the cabinet 10. For brevity, the heat transfer element, control circuit board is referred to hereinafter as circuit board 52.

The circuit board 52 is comprised of a computer 54, preferably embodied as a single-chip microcontroller having re-programmable flash memory or RAM on the same die, and a serial and/or parallel communications interface through which the computer 54 can communicate with other devices in the cabinet 10 via a bus, described more fully below. In an alternate embodiment, the circuit board 52 includes a microprocessor and one or more external memory devices, not shown in FIG. 6 but preferably embodied as EEPROMs.

In addition to the computer 54, the circuit board 52 includes either high power field effect transistors (FETs), silicon controlled rectifiers (SCRs), TRIACs or relays, or a mixture of such devices to effectuate control of the electric energy provided to heat transfer devices in the cabinet. Semiconductors as well as mechanical relays, which are used to control electricity provided to the heat transfer elements, are collectively referred to herein as current-controlling semiconductor devices 59.

The current-controlling semiconductors 59 are electrically coupled between an external power source not shown in FIG. 6 and one or more heat transfer elements. The heat transfer elements include the heating elements 51 shown in FIGS. 2 and 3, disclosed in the applicants' co-pending patent application entitled, UNIVERSAL FOOD HOLDING CABINET WITH SNAP-IN ESCUTCHEONS, having Ser. No. 12/618,939 and which was filed Nov. 16, 2009, the entire contents of which are incorporated herein by references. The 12/618,939 application and this application are assigned to the same entity.

In addition to current control devices 59, the circuit board 52 includes circuitry 57 to interface (electrically couple) the computer 54 to the aforementioned user interfaces in the escutcheons 26 as described above and in the aforementioned co-pending application. Circuits and devices that interface a computer to an LED, LCD display, electronic paper, bulbs, switches, temperature sensors and keyboards are well known in the art. Such devices are too numerous to name but include devices such as analog-to-digital (A/D) converters, digital-to-analog converters, display drivers and the like. There are many devices that couple a computer to a peripheral device and a description of them is omitted for brevity. Regardless of how signals from peripherals to the computer 54 are coupled to it, the electrical signals exchanged between the devices in the cabinet, e.g., user interfaces in the cabinet 10 and in the escutcheons, sensors, and the computer 54, determine how the computer's program instructions, when executed, effectuate temperature control of a compartment 23.

The current-controlling semiconductor devices 59 receive their control signals from the computer 54 such that signals they receive from the computer 54 modulates or switches the current to the temperature control devices 51 in the cabinet. The control signals that the computer 54 sends to the semiconductor devices 59 are determined by the computer's executable program instructions as well as data (non-executable) stored in memory and signals the computer 54 receives from devices in the cabinet 10. The stored program instructions and/or data in memory, and/or provided to the computer 54 from the cabinet 10, thus determine how current is to be delivered to the heat transfer elements 51 and thus the temperature inside the compartments 23. Changing the program instructions in the computer 54 and/or changing data in the computer 54 thus enables changing how the computer 54 controls the semiconductor devices 59, and in turn, the temperature or other condition inside a compartment 23.

In FIG. 6, the circuit board 52 is shown as having three separate connectors 58 located at one edge of the circuit board 52. The different connectors on the circuit board 52 are identified by reference numerals 58A, 58B and 58C. The connectors 58 mechanically and electrically engage and mate with corresponding connectors 62 that are electrically and mechanically attached to a motherboard 60 mounted orthogonally to the sidewall 18 of the cabinet 10.

The motherboard 60 is elongated and provided with multiple sets of connectors 62 to enable multiple circuit boards 52 to be connected to it. Conductors inside ribbon cable 76 and other wires not shown, are connected between contacts on the motherboard 60 (contacts not shown), a master controller 70 for the cabinet 10, heat transfer devices 51, and user interfaces on the escutcheons and cabinet. The connectors 58 and 62, motherboard 60, ribbon cable 76 and other wires thus enable signals to be exchanged between the computer 54 and other devices on the circuit board 52 and devices external to the circuit board 52.

Devices external to the circuit board 52 include temperature control elements 51, user interface devices in the escutcheons, temperature sensors and a master controller 70 in the electronics compartment 15. Alternate and equivalent embodiments of the circuit board 52 use, one, two or more connectors shown in the figure. Other embodiments use circuit board edge connectors, well known to those of ordinary skill in the art. For purposes of simplicity and brevity, connectors of any kind that enable the electrical connection of devices on the circuit board 52, to devices external to the circuit board 52 are collectively referred to herein interchangeably as a connector or an edge connector.

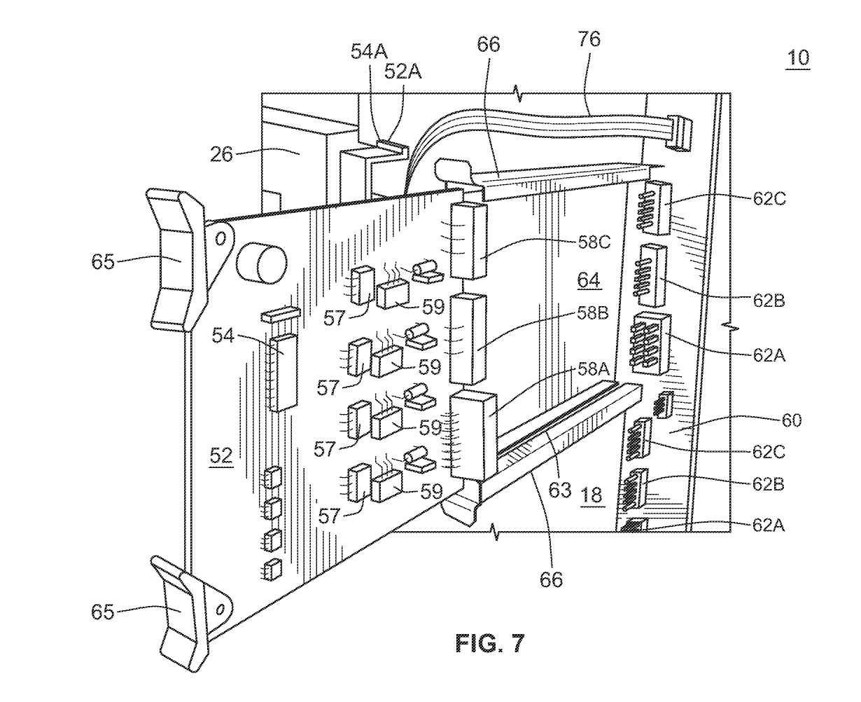

As shown in FIG. 7, a circuit board 52 is slid on its side edges into grooves 63 formed into opposing edges of two brackets 66, which are themselves mechanically attached to the motherboard 60 to extend orthogonally away from the motherboard 60. The brackets 66 are spaced apart from each other and the grooves 63 deep and wide enough to allow the circuit board 52 to freely slide in and out of them. The brackets 66 thus removably support the circuit boards 52.

The brackets 66 are separated from the sidewall 18 of the cabinet 10 by a small distance such that the height of electronic components on the circuit board 52 will not clear the sidewall 18 if the circuit board 52 is inserted into the brackets 66 with the component side of the circuit board facing the cabinet sidewall 18. The location of the brackets 66 on the mother board 60 relative to the cabinet sidewall 18 thus prevents the circuit board 52 from being inadvertently inserted upside down, i.e. in an improper orientation. The brackets 66, in combination with the cabinet sidewall 18 effectively form a card cage, which prevents the circuit boards 52 from being installed incorrectly into the motherboard 60.

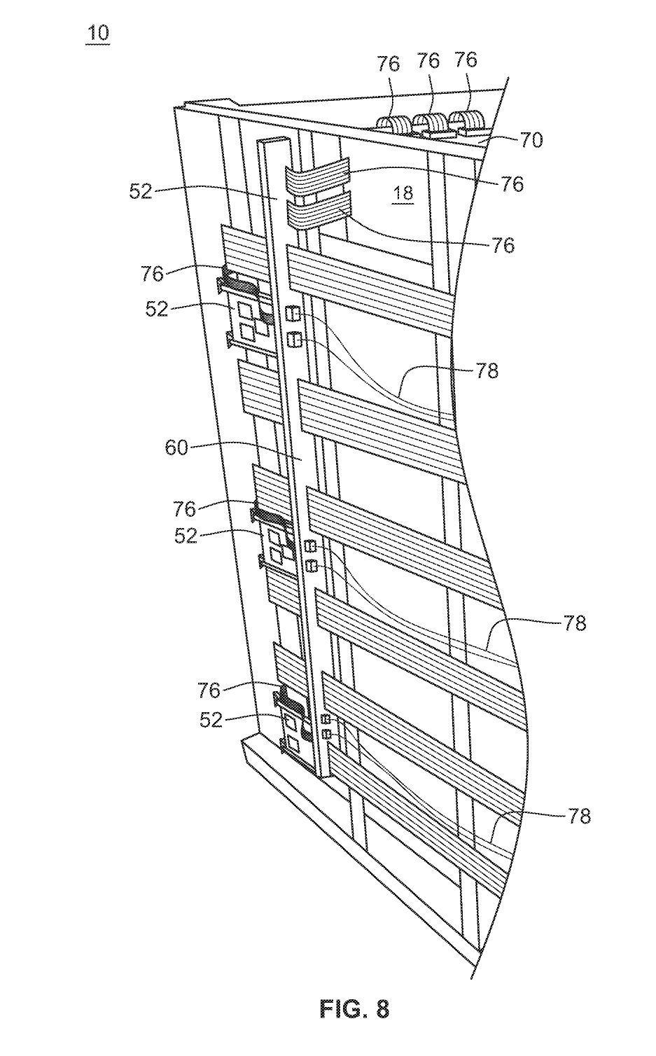

FIG. 8 is a perspective view of the right side of the preferred embodiment of the cabinet 10, viewed from the rear of the cabinet 10. The ribbon cables 76 can be seen connected between the mother board (connections on the mother board not visible but well known to those of ordinary skill) and a master controller/computer 70 located in the electronics compartment 15. Conductive circuit “traces” on the mother board in turn carry electrical signals on the ribbon cable conductors, to various terminals of the connectors 62. (The conductive traces or paths on the mother board 60 are not visible in the figure but such traces are well known to those of ordinary skill in the electronic arts.)

Wires in the ribbon cables 76 carry various signals that include address signals, data signals and control signals, which are exchanged between the master controller 70 and a computer 54 on a circuit board 52 connected to the mother board 60. The ribbon cables 76 are thus considered herein to both provide and act as a “bus” between the master controller 70 and various computers 54 to which the bus is connected to.

The concept of a bus carrying various different digital signals between a computer and devices peripheral to the computer, is well known to those of ordinary skill in the electronic art. Since the functionality of the bus is effectuated by the ribbon cables (and equivalents thereof), for purposes of simplicity, the terms “bus” and “ribbon cable” are thus used interchangeably hereinafter. For purposes of clarity, both of them are identified by reference numeral 76.

The computer 54 on the circuit board 52 is responsive to commands it receives from the master controller over the bus 76. It is also responsive to information and inputs it receives from devices peripheral to it, such as the escutcheon-located user interface devices and one or more temperature sensors, not shown. The computer 54 is thus considered to be “slaved” to the master controller 70.

As shown in FIG. 5, a preferred embodiment of the cabinet 10 has multiple circuit boards 52, each of which has at least one computer 54. Each computer 54 on each circuit board 52 is therefore slaved to the master controller.

Each computer 54 on each circuit board 52 is coupled to the same bus 76 such that each computer 54 “sees” all of the “information” on the bus 76. The master controller 70 selectively communicates with a particular slave computer 54 using an address for each slave computer 54.

In a preferred embodiment, the communications between computers is via a serial communications protocol reminiscent of Ethernet. Messages from a sender are broadcast on the bus. Broadcast messages are received and selectively acted upon by the recipient to which a message was addressed.

Packets sent over the bus include a field that identifies the source of a packet by the logical address of the sender and a second field that identifies the recipient of the packet by its logical address. A packet payload contains all or part of a message being sent from the sender to the recipient.

As stated above, the circuit boards 52 provide power from an external source to a particular heat transfer element for a particular shelf 21 under software control, i.e., under the control of a program running in the computer 54 on the circuit board 52. In order to selectively direct messages to a particular computer 54 and to selectively respond to messages broadcast on the bus 76 from a particular computer 54, each computer 54 on each circuit board 52 acquires from the mother board 60 via one of the connectors 62, a unique address that corresponds to the circuit board's location in the mother board 60. A circuit board's location on the mother board 60 also corresponds to one or more shelves 21 that the computer 54 on the circuit board 52 is required to control. Stated another way, message packets are “addressed” to a particular computer 54 or from a particular computer according to the particular card cage 64 wherein the computer 54 is installed in the cabinet 10. Commands and/or data from the master controller can thus be addressed to and received by a particular computer 54 on the bus 76 according to the particular shelf 21 that a computer 54 is to control.

The address of a particular card cage and thus a computer 54 on a circuit board 52, is effectuated by electrically connecting various pins of the connector 62 to either V_{cc} or ground, which represent logic 1 and zero respectively. When the connectors 58 on the circuit board 52 engage the connectors 62 on the mother board 60, executable program instructions stored in memory for the computer 54, cause the computer 54 to “read” its logical address from the mother board 60. In an alternate and equivalent embodiment, signal leads on the mother board 60 apply voltages of V_{cc} or ground to pins of the connectors 62 installed into the mother board 60. In yet another embodiment, so-called DIP switches are used on the circuit boards 52 instead of connectors and configured “on” or “off” to provide a card cage address to the computer 54.

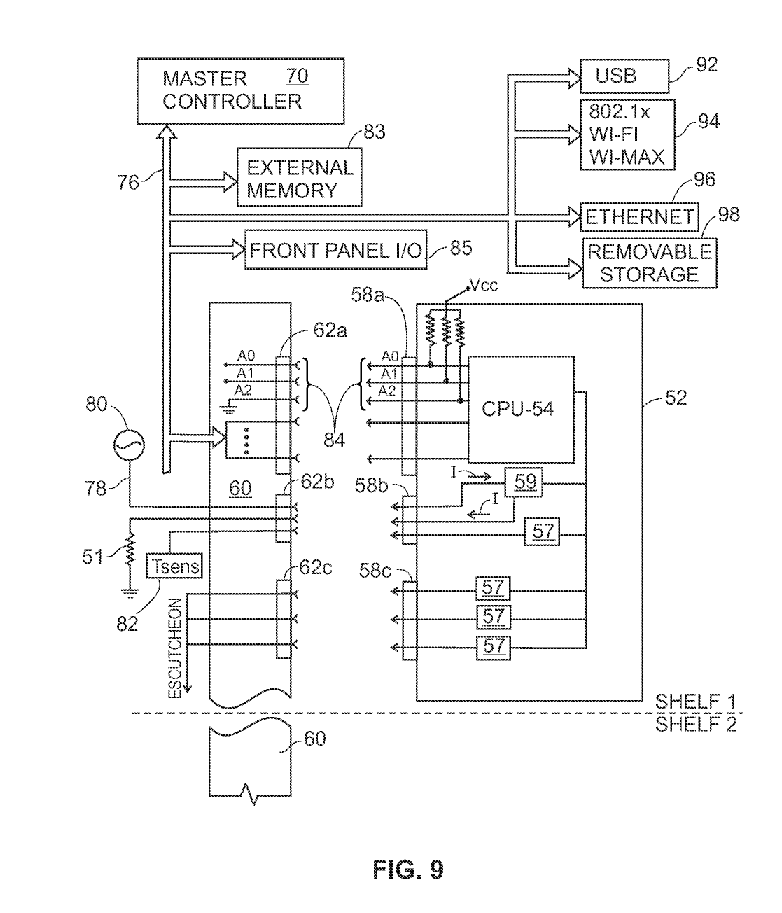

FIG. 9 is a block diagram of the electronic devices that control the cabinet 10. As state above, the master controller 70 communicates with electronic devices located on a control circuit board 52 via a bus that carries address, data and control signals.

Ribbon cable conductors that comprise the bus are connected to corresponding terminals or connection points on the motherboard 60. Conductive paths or “traces” on the motherboard, carry the signals that were on the ribbon cable, to different terminals of different connectors 62A, 62B and 62C. A first pair of connectors 62A and 58A that connect to each other, convey signals between the controller 54 and the master controller 70.

Three address lines on the mother board 60 denominated as A₀, A₁ and A₂ are identified in FIG. 9 collectively by reference numeral 84. The address lines, A₀ and A₁ are “pulled-up” to V_{cc} on the circuit board 52 through pull-up resistors on the circuit board 52. The V_{cc} voltage is applied to the pull-up resistors when the circuit board 52 is seated into at least one of the connectors 62 on the mother board 60. The third address line A₂ is pulled down to ground by a corresponding address line A₂, located on the mother board 60.

As shown in the figure, voltages on the three address lines 84 correspond to a binary-valued or digital address of card cage 1 for shelf number 1 in the cabinet 10. When a control circuit board 52 is inserted into the card cage such that the connectors 58 & 62 engage, the controller 54 on the circuit board 52 reads the address of the card cage/shelf as a binary “110” (one, one zero; decimal value 6) by reading the voltages on the three address lines 84. The controller 54 thus determines which shelf it is in, and which shelf it is responsible for controlling.

Hard-wiring an address for a particular shelf of the cabinet enables software in the controller 54 to determine where it is installed and how it is to operate. Shelf 1 could be used to keep certain types of foods at a high temperature whereas another control board 52 in another card cage 64 for a different shelf could be required to keep shelf 2 cold or at a lower, cooler temperature than shelf 1. Imbuing the control boards 52 with the ability to read their locations on the mother board enables flexible control of the cabinet 10 operation.

Still referring to FIG. 9, a second pair of connectors 58B & 62B provide connections between the power supply devices 59, an external power source 80 and heat transfer elements 51. An interface 57 couples a temperature sensor 82, to the CPU 54. A third connector set 58C & 62C couple signals to and from the escutcheon 26 through other interface devices 57 which are themselves coupled into the CPU 54.

The master controller 70 is depicted as being connected to an external memory device 83 via the bus 76. Those of ordinary skill in the art will recognize that the master controller 70 is preferably a single chip microcontroller with its own on board RAM, ROM and EEPROM. The bus also couples the master controller 70 to the cabinet's front panel input/output-user interface devices described above. Finally, the master controller 70 is also coupled to various communications devices through which the master controller 70 can communicate with the outside world. The interfaces for external communications may include a USB port 92, an 802.1x (WI-FI or WI-MAX) wireless interface 94 as well as an Ethernet interface 96, removable storage device such as a CD or DVD drive, SIM cards or other removable storage media 98. The external communication interfaces 92, 94 and 96 enable the master controller 70 to receive executable program instructions and data for either the master controller 70 or the slave CPU 54.

In a preferred embodiment, the memory on board the master controller die 70 includes memory that stores executable program instructions for the slave computer 54 as well as data. In an alternate embodiment, the executable program for the slave computer 54 and data can also be stored in the external memory 83.

Storing the program executed by the slave computer 54 in the master controller provides several benefits. Firmware for the slave computer 54 can be kept up-to-date by acquiring new programs via one or more of the external communications interfaces. It also allows the firmware for the slave computer 54 to be changed based on customer requirements or food holding requirements.

In a first embodiment, the slave computer 54 on the circuit board 52 is pre-programmed with only a small program, which reads the address of the shelf wherein it is located from the mother board 60. Other instructions issue a request to the master controller 70 via the bus, asking the master controller 70 for a download of instructions that will give the slave controller 54 its “personality.” In yet another embodiment, the slave computer 54 is pre-programmed with enough code for it to notify the master controller of its presence on the bus and to thereafter wait for a download from the controller 70. In yet a third embodiment, all of the operating instructions are burned into the slave computer 54, however, operating parameters such as temperatures to maintain a compartment at, or food holding time limits are downloaded from the master controller 70 or received through one or more of the user interfaces. In yet another embodiment, the slave computer 54 is pre-programmed with sufficient instructions that enable it to take control of the bus 76 and download its operating program and/or data from the external memory under its own control. Once the program instructions are down loaded from the external memory, the slave computer 54 can thereafter operate autonomously, subject of course to the control instructions it receives from the master controller.

It should be noted that all of the download provided to the slave computer 54 include software that reads and controls the user interfaces of the escutcheons for a particular shelf. Such software includes instructions and data to display information to an operator.

In yet another embodiment, the downloaded software includes diagnostics that can test devices on the circuit board 52 as well as the functionality of heat control elements 51, temperature sensors 82.

Master/slave communications over the bus 76 include: downloading commands to the slave computers 54 from the master controller; uploading commands/requests from the slave computers 54 to the master controller; downloading operating parameters, i.e., data to the slave computers from the master controller; uploading collected data from the slave computers 54 to the master controller; and, downloading executable program instructions from the master controller to one or more of the slave computers 54, which when loaded into a slave computer, change the operating characteristics or “personality” of a slave computer 54 into which the new program instructions are installed.

In a preferred embodiment, the download is requested by the slave computer 54. In an alternate embodiment, the computers 54 are considered to be master controllers vis-à-vis the computer in the electronics compartment 15. In such an embodiment, the master controller computer 54 can request a download of executable instructions and or data.

The foregoing description is for purposes of illustrations only. The true scope of the invention is set forth in the appurtenant claims.

What is claimed is:

1. A temperature-controlled food holding cabinet (food holding cabinet), configured to maintain a food item at a substantially constant temperature, the food holding cabinet comprised of:
a chassis;
a food holding compartment (compartment) within the chassis, the compartment being defined by spaced apart shelves in the chassis;
an electrically-powered heat transfer element (element) thermally coupled to the compartment, the element effectuating a temperature inside the compartment;
a control circuit board (circuit board) comprised of a computer, a power supply device for the element and a first type connector, the power supply being coupled to and responsive to the computer;
a mother board comprised of a second type connector, the second-type connector configured to mate with the first type connector, at least one of the second type connector and the mother board providing an address to the computer when the first and second edge type connectors are engaged.

2. The food holding cabinet of claim 1, further comprised of a circuit card cage configured to receive the circuit board in a single spatial orientation relative to the chassis and mother board, guide the circuit board into engagement with the mother board, and support the circuit board.

3. The food holding cabinet of claim 2, wherein the card cage is comprised of first and second grooved brackets extending orthogonally away from the mother board.

4. The food holding cabinet wherein the compartment is further comprised of at least one vertical wall extending between first and second horizontal shelves, the at least one vertical wall defining first and second sub-compartments.

5. The food holding cabinet of claim 1, wherein the mother board is configured to provide the address to the computer by providing a reference potential voltage to an input of the computer.

6. The food holding cabinet of claim 1, wherein the second type connector is configured to provide the address by providing a reference potential to the computer.

7. The food holding cabinet of claim 1, further comprised of a master controller and a bus, and wherein the computer is a slave to the master controller, said bus connecting the master controller to the slave computer.

8. The food holding cabinet of claim 1, wherein the element is a heating element.

9. The food holding cabinet of claim 8, wherein the heating element is embedded within a shelf.

10. The food holding cabinet of claim 9, wherein the temperature inside a compartment is determined by electric current provided to the heating element by the power supply device on the control circuit board.

11. The food holding cabinet of claim 4, further comprised of an element thermally coupled to the at least one vertical wall.

12. The food holding cabinet of claim 11, wherein the temperature inside a compartment is determined by electric current provided by the power supply device on the control circuit board.

13. The food holding cabinet of claim 1, wherein the computer is a bus slave.

14. The food holding cabinet of claim 1, wherein the computer is a bus master.

15. A temperature controlled food holding cabinet (food holding cabinet), configured to maintain a food item at a substantially constant temperature, the food holding cabinet comprised of:
a chassis having a top, a bottom, left and right sides and front and rear sides;
a plurality of shelves within the chassis, the shelves defining food storage compartments;
a heat transfer element (element) thermally coupled to each shelf;
a control circuit board (circuit board) comprised of a computer, a first type connector and a power supply device coupled to the computer, the power supply device being configured to deliver varying amounts of power to the element in response to signals it receives from the computer;
a mother board having a second type connector mating with first type of connector, whereby connection of the first type of connector on a circuit board with the second type connector on the mother board, the computer on the circuit board is provided an address for use on a bus;
a card cage fixed to a first side of the chassis, the card cage being configured to receive the circuit board in a single spatial orientation relative to the mother board and relative the chassis, the card cage being further configured to releasably support the circuit board when the first type connector on the circuit board is engaged with a corresponding second type connector on the mother board.
